(19) United States
(12) Patent Application Publication
(10) Pub. No.: US 2013/0260714 A1
(43) Pub. Date: Oct. 3, 2013

(54) METHOD AND DEVICE FOR DETERMINING RATING DATA FOR SERVICE USAGE IN AN ELECTRONIC COMMUNICATION NETWORK

(71) Applicant: Telefonaktiebolaget L M Ericsson (publ), Stockholm (SE)

(72) Inventors: Stefan KARLSSON, Karlskrona (SE); Anders Olsson, Karlskrona (SE)

(21) Appl. No.: 13/893,887

(22) Filed: May 14, 2013

Related U.S. Application Data
(62) Division of application No. 11/887,272, filed on Jul. 23, 2009.

(51) Int. Cl. H04W 4/26

(52) U.S. Cl. CPC H04W 4/26
USPC 455/406

(57) ABSTRACT

A charging device and method determines rating data for charging of services in an electronic communications network. A modifier operator (56, 76) of a node (46, 66) is accessed in a rating analysis in response to a charging request from a service element for a requested service in the electronic communications network. The modifier operator (56, 76) performs at least one operation involving a number of modifiers (46, 27, 48, 66, 67, 68), and returns a result from the at least one operation.

This application is a Divisional Application of U.S. patent application Ser. No. 11/887,272, filed Sep. 27, 2007, which is the U.S. national phase of International Application PCT/SE2005/000475, filed Mar. 31, 2005 which designated the U.S., the entire contents of each of which is hereby incorporated by reference.

### FIELD OF THE INVENTION

The technology disclosed herein relates generally to charging in a communications network and more particularly to a method and device for determining rating data for charging of services in a communications network.

### DESCRIPTION OF THE PRIOR ART

Charging for usage of services in communications networks, for example PLMNs (public land mobile network) such as GSM, CDMA, UMTS, public switched telecommunications networks (PSTN), ISDN, ATM, Internet etc. and their associated services is achieved by means of a payment mechanism performing a charging process including a method of determining rating data for charging requested and used services. Both post-paid and pre-paid systems are used.

Said mobile telephone communications networks provide different tele and data communications services, for example regular phone calls, SMS, EMS, MMS, e-mail, WAP, GPRS, etc for users and providers, regional as well as world-wide.

Up to the introduction of GPRS (General Packet Radio Services) there has been little need of combining several costs during the same interval, i.e. during an ongoing session, or to select costs out of a set of given costs. With the introduction of GPRS several costs can apply to an action, e.g. a bearer cost and a service cost. For MMS (multi media message service) it could be a bearer, the number of recipients in the source mobile network, the number of recipients in other mobile networks, recipients on the Internet and the size of the message. Prior art systems for rating analysis has a rating tree with branches ending up with one cost as shown in FIG. 3, e.g. a rate or fee that will make up the cost together with the needed/used time.

A service element that can request services is for example an SSF via CAP or INAP, HLR via MAP, HSS (Home Subscriber Subsystem) and web servers/application servers via Diameter, SIP, open API via IP, i.e. OSA/Parlay, XML web-services, via SOAP or any other server with an application requiring charging support, such as an e-commerce site movie/music server for streaming, a news site, WAP server or an SMSC/MMS-C. In those cases the charging input parameters can include for example an article identifier, number of events, kind of event, service, local time, destination number, originating or terminating location, distance, QoS, number of time slots, or utilised capacity etc.

Determination of rating data in a prior art system involves a service data point (SDP) having a database containing service data needed for the service, including for example tariff data, subscriber data, group data etc. The service data point handles the rating, wherein a charging and rating function collects or accesses charging input parameters or data such as: service data, subscriber related data, session data, call data, system data etc, received from an external service element of a service requested by a subscriber. One example of a requested service is to send an MMS of N kBytes to two internal HPLMN (Home PLMN) subscribers and one external HPLMN subscriber. The total cost for the three MMSs will be NkB*kBrate+2*Fee for HPLMN receivers+1*Fee for non-HPLMN receivers. According to the prior art system described above a charging and rating function performs rating of the requested service in response to at least one rating request or system call to the rating tree of the CCRF for each MMS. A communication system involving a huge number of subscribers accessing a great number of similar and/or different services requiring a lot of system resources due to the rating tree accesses. In a one-by-one invocation the first invocations could take all resources leaving nothing left for the next invocation for the same event. This will effectively starve the execution of the complete event.

### SUMMARY

Therefore, it is an object of the technology disclosed herein to provide a method and rating device for determining rating data for service usage in an electronic communications system or network that overcomes the problem and disadvantages set forth above in connection with the prior art.

This object is achieved by a method for determining rating data for charging of services in an electronic communications network, including the steps of in response to a charging request from a service element for a requested service in the electronic communications network, accessing a modifier operator of a node in the rating tree, said modifier operator performing at least one operation involving a number of modifiers, and returning a result from said at least one operation.

The object is further achieved by a rating device for determining rating data in the electronic communications network. The rating device has means for accessing a modifier operator of a node leaf in a rating tree in response to a charging request from a service element for a requested service in the electronic communications network, wherein said modifier operator is configured to perform at least one operation involving a number of modifiers, and return a result from said at least one operation. An advantage of the technology disclosed herein is to handle the reservation for the complete cost at one time since optimizations of distribution of resources that are limited could be made. This is applicable but not limited for reservations of funds where the account is being emptied of funds or credits.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In order to explain the technology disclosed herein in more detail and the advantages and features of the technology disclosed herein, a preferred embodiment will be described in detail below, reference being made to the accompanying drawings, in which

FIG. 1 is a schematic view of an embodiment of a communications network including a rating device and a charging device according to the technology disclosed herein,

FIG. 2 is a schematic view of a part of the communications network of FIG. 1 in further detail,

FIG. 3 illustrates a part of a prior art rating tree,

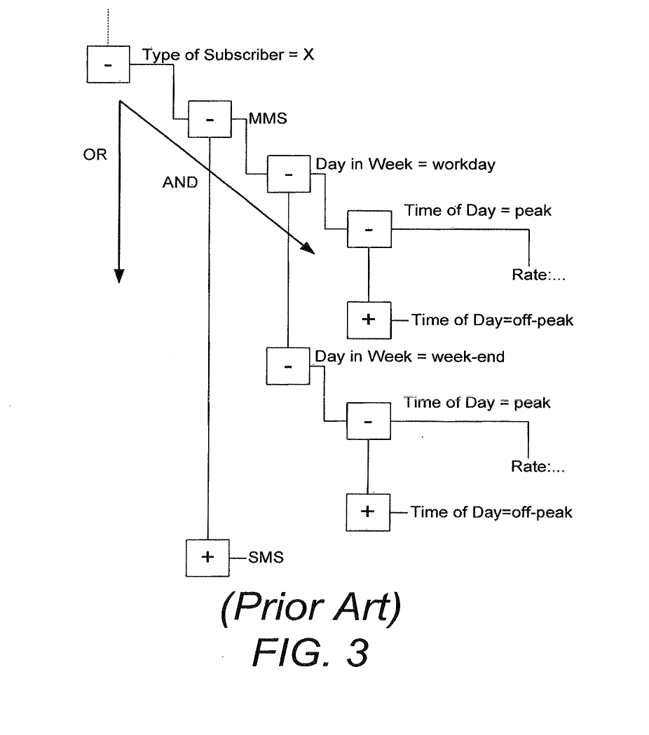

FIG. 4 illustrates a first embodiment of a part of a rating tree of a rating device according to the technology disclosed herein,

FIG. 5 is a flowchart of a first embodiment of the method according to the invention,

FIG. 6 illustrates a second embodiment of a part of a rating tree of a rating device according to the technology disclosed herein, and

FIG. 7 is a flowchart of a second embodiment of the method according to the technology disclosed herein.

### DETAILED DESCRIPTION

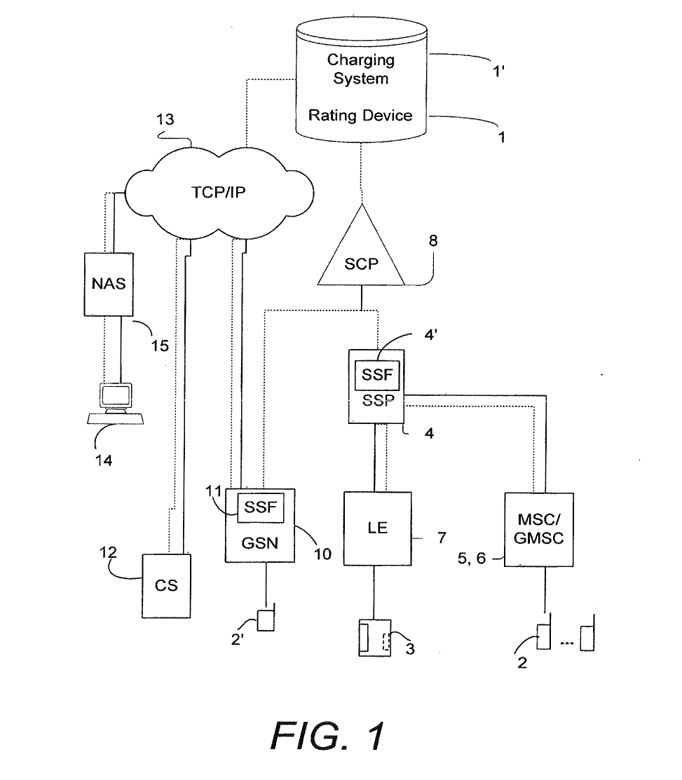

Referring to FIG. 1, there is shown an example of a communications network including a rating device 1 according to the technology disclosed herein for determining rating data involving combined costs for service usage in an electronic communications system or network by means of reduced rating tree accesses. The rating device 1 forms part of a charging device or system 1′ providing efficient charging analysis according to the technology disclosed herein. The communications system or network is, but is not limited to PLMNs (public land mobile network), for example a cellular mobile telephone network, such as GSM, or CDMA, or UMTS, including a service providing network, such as an intelligent network (IN) facilitating service delivery for subscribers connected to the network. In this embodiment, the network also provides a pre-pay option and a method for determining rating data for pre-paid services for subscribers in the communications network. The pre-pay option is only one example of a method for charging for services in a communications network, but this mechanism is not necessary for the technology disclosed herein. A post-pay option or other method of charging is likewise possible within the scope of the technology disclosed herein.

A user may access the charging device 1′ providing a charging and rating function CRF via a number of access methods which are further described with reference to FIG. 1. If the charging device 1′ is accessed via a user terminal such as a portable radio communication equipment 2 or a fixed telephone 3, the invocation is performed by a service switching point (SSP) 4 and its service switching function (SSF) 4′ via an intermediate MSC/GMSC 5/6 for the portable radio communication equipment 2 and a local exchange (LE) 7 via a service control point SCP 8 for the fixed telephone 3.

The term portable radio communication equipment, which herein after is referred to as a mobile phone, includes all equipment such as pagers, communicators, i.e. electronic organizers, smartphones or the like.

The GMSC 5, i.e. gateway mobile services switching centre, or only MSC 6, i.e. mobile services switching centre, provides specific data about individual mobile phones 2 in the network and operates as an interface towards other networks such as other PLMNs, ISDN or a public switched network (PSTN) in the communications system.

If the charging device 1′ is invoked due to usage via a mobile phone 2′ with GPRS capabilities, a GSN (GPRS support node) 10 will directly invoke the charging device 1′ by its co-located service switching function (SSF) 11 via the SCP 8. If invoked due to usage of a service at a content server (CS) 12 connected to the Internet 13 accessed from a data terminal 14 through a network access server (NAS) 15, the content server (CS) 12 can directly access the charging device 1′ via a TCP/IP network, such as the Internet 13. Access to an application server via a mobile phone will operate in the same way as when accessing from the data terminal 14, wherein the GSN 10 is operating as the NAS 15.

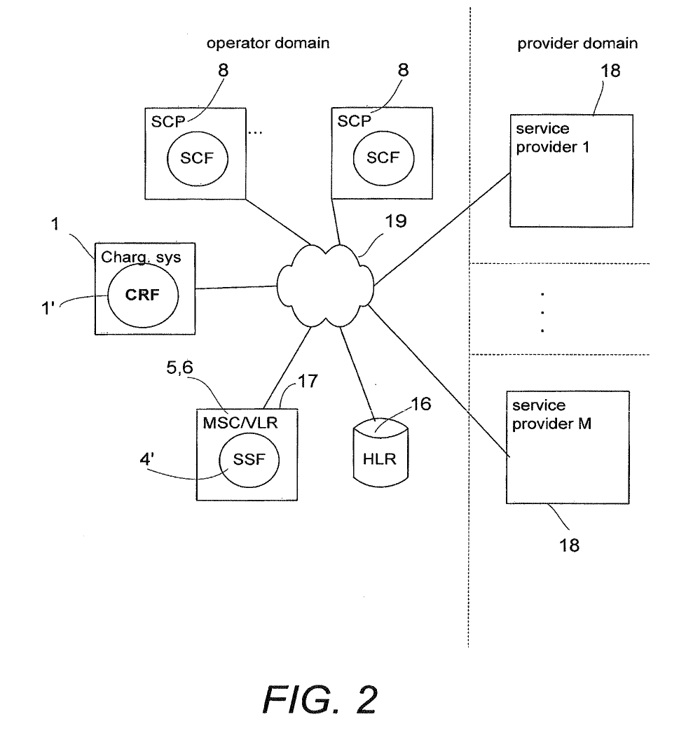

FIG. 2 illustrates an example of a communications system with a number of providers within which the technology disclosed herein can be implemented. The technology disclosed herein can however be implemented in communication systems with other configurations. According to this example embodiment, the SCP 8 is a real-time database and service processing system that, based on a query from the SSF 4′, performs subscriber- or application-specific service logic, controlling the call set-up and call flow. A home location register (HLR) 16 stores the identity and user data of all the subscribers belonging to the PLMN. Further, the HLR 16 provides the GMSC/MSC 5/6 with the necessary subscriber data when a call is coming from a public switched network (PSTN), an ISDN network, the Internet etc. A visitors location register (VLR) 17 contains relevant data of all mobile phones currently located or roaming within a serving GMSC/MSC 5/6. The VLR 17 has to support the GMSC/MSC 5/6 during call establishment when a call is initiated from a mobile telephone.

The charging device 1′ of FIG. 1 contains a database with service data needed for the service, including for example tariff data, subscriber data, group data etc. In this embodiment, rating and charging analysis is handled in the charging device 1′, its rating device 1, SCP 8 and/or one or several providers 18, or other external devices.

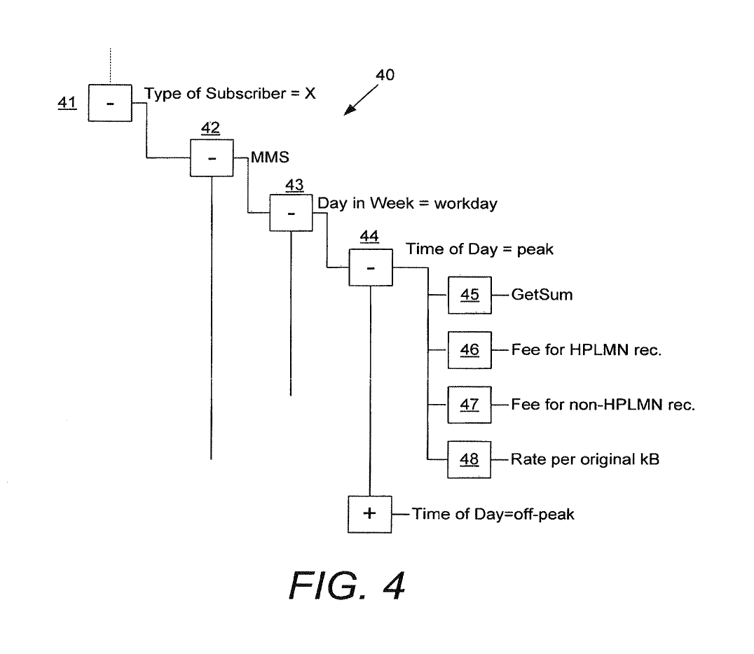

FIG. 4 illustrates a first embodiment of a part of a rating tree 40 of a rating device 1 according to the technology disclosed herein. A branch of the rating tree comprises a “Type of Subscriber=X” node 41, followed by an “MMS” node 42, followed by a “Day in Week=workday” node 43, followed by a “Time of Day=peak” node 44. The last node 44 of the branch has two or more modifiers or leafs. According to this particular example the rating tree 40 has—but the technology disclosed herein is not limited thereto—a modifier operator and three different modifiers in the node 44: A “GetSum” modifier operator 45, a “Fee for HPLMN receivers” modifier 46, a “Fee for non-HPLMN receivers” modifier 47, and a “Rate per original kB” modifier 48. Although, it is not explicitly expressed in the FIG. 4 the modifiers are implemented with real values. The fees are for example expressed in an amount of a currency.

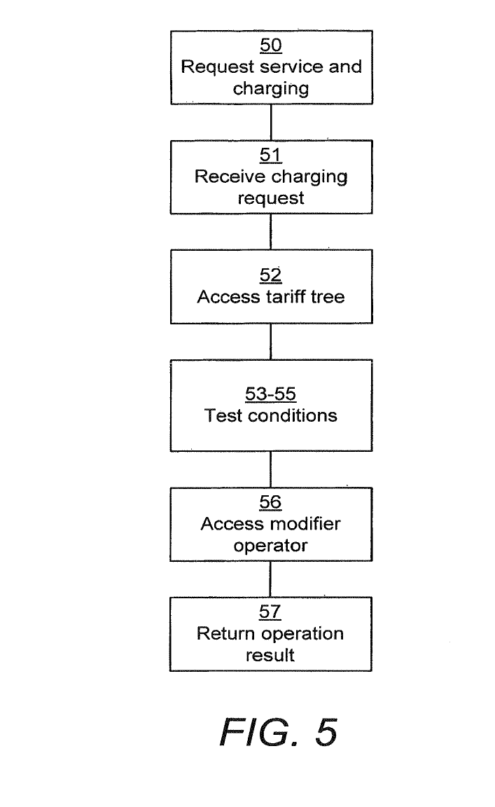

FIG. 5 is a flowchart of a first embodiment of a method for rating according to the technology disclosed herein. In this particular example the method operates on the rating tree of FIG. 4. The charging and rating function starts and is triggered by a request from a user via its mobile phone 2,2′, fixed telephone 3, or data terminal 14 and proceeds with traversing the tariff structure in FIG. 4, while calculating the cost of a purchase or a chargeable event. One example of a requested service is to send an MMS of N kBytes from a subscriber typ X having a mobile phone 2 as shown in FIG. 1 to two internal HPLMN subscribers and one external HPLMN subscriber. Thus, the service is requested by a user of the mobile phone 2 in step 50. A signal triggering the charging and rating function is transmitted to the charging device 1′ via the MSC 5 to the SSP 4 to the SCP 8 and is received by the rating device 1 of the charging device 1′. According to this embodiment of the method the rating device 1 receives the signal and necessary parameters for a requested charging in step 51. The rating device configured to access its tariff or rating tree, accesses its tariff tree including the branch 40 of FIG. 4 in response to the requested service, i.e., the MMS, in step 52. The rating is performed by entering the branch 41 in step 52 followed by testing of the conditions 42-44 one after the other in steps 53-55. If the last condition is fulfilled the rating proceeds by accessing the GetSum modifier operator 45 in step 56. Relevant parameters including data indicating the number of kBs and the number of MMSs to be sent to different receivers are also provided when accessing the GetSum modifier operator 45. Depending on the parameters provided to the GetSum modifier operator, the operator returns the sum of the modifiers in the set of modifiers in step 57, i.e., one or more of the modifiers 46-48 are added to form a result returned by the rating device 1 to the charging request. Operations performing the following expression is performed in step 56 in this embodiment for calculating the total cost for the three MMSs: NkB*kBrate+2*Fee for HPLMN receivers+1*Fee for non-HPLMN receivers. The Fee for HPLMN receivers and Fee for non-HPLMN receivers is usually of different values but can be the same.

The steps 50-57 can include one or more additional sub-steps, all of which are not described herein in detail. Although steps 53-56 are disclosed as one sequence these steps can be repeated more than once in alternative embodiments of the technology disclosed herein. Other examples of requested services combine time and volume, i.e., getting the price for a data connection, combining the time the user is active (attached or has activated his PDP context) and the data volume that has been used. Additionally this could be separated also into time, uplink data volume and downlink data volume. Further the following parameters could be combined for the same situation: relative time (time in session), absolute time (time of day) and used volume.

Another service gives the user his local weather forecast. Charging data to be combined could be: volume used, cost for the positioning of the user, cost for the data fetched from the weather database, orchestrating application cost. All this cost could be requested from different parties.

The charging and rating function CRF of the charging device or system 1′ collects or accesses charging input parameters or data such as: service data, subscriber related data, session data, call data, system data etc, received from the external service element of a service requested by a subscriber.

The subscriber has an account registered for one or more services at a service provider. A service element that can request services is for example an SSF (service switching function) via CAP (Camel application part) or INAP (Intelligent network application part), SCF (service control function) via CAP or INAP, HLR (Home location register) via MAP (mobile application part), HSS (Home Subscriber Subsystem) web servers/application servers via Diameter, SIP (session initiation protocol), open API via IP, i.e., OSA/Parlay, XML web-services via SOAP or any other server with an application requiring charging support, such as an e-commerce site movie/music server for streaming, a news site, WAP server or an SMSC/MMS-C. The charging input parameters are an article, number of events, kind of event, service, local time, destination number, originating or terminating location, distance, QoS, number of time slots, or utilised capacity etc.

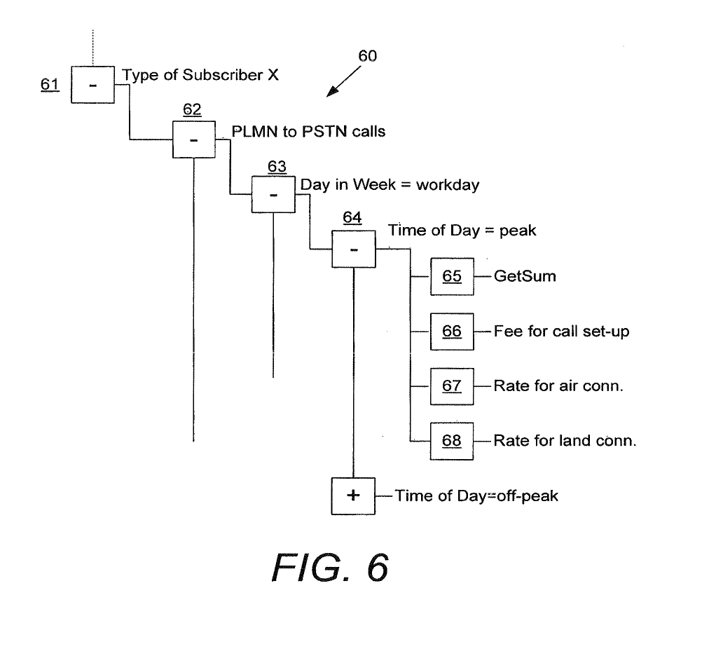

FIG. 6 illustrates a second embodiment of a part of a rating tree 60 of a rating device 1 according to the technology disclosed herein. A branch of the rating tree comprises a “Type of Subscriber=X” node 61, followed by a “PLMN to PSTN calls” node 62, followed by a “Day in Week=workday” node 63, followed by a “Time of Day=peak” nod 64. The last node 64 of the branch has two or more modifiers or “leaves”. This particular example has but the technology disclosed herein is not limited to a modifier operator and three different modifiers in the node 64: A “GetSum” modifier operator 65, a “Fee for call set-up” modifier 66, a “Rate for air connection” modifier 67, and a “Rate for land connection” modifier 68.

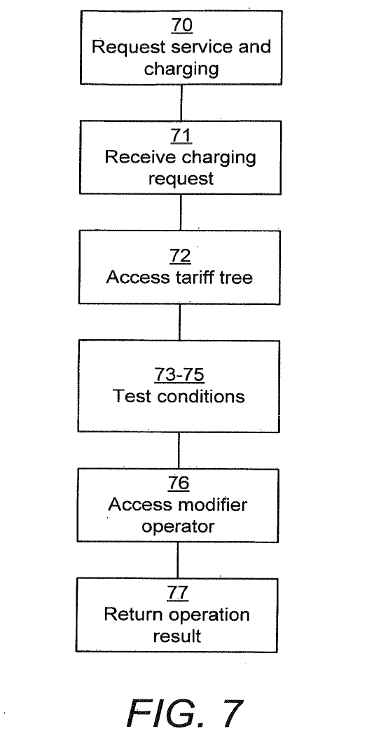

FIG. 7 is a flowchart of a second embodiment of a method for rating according to the technology disclosed herein. The charging and rating function starts and is triggered by a request from a user via its mobile phone 2,2′ and proceeds with traversing the tariff structure in FIG. 4, while calculating the cost of a purchase or a chargeable event. According to this example of a requested service is to make a call from a subscriber typ X having a mobile phone 2 as shown in FIG. 1 to a PSTN subscriber. Thus, the service is requested by a user of the mobile phone 2 in step 70. A signal triggering the charging and rating function is transmitted to the charging device 1 via the MSC 5 to the SSP 4 to the SCP 8 and is received by the charging device 1. According to this embodiment of the method the rating device 1 of the charging device 1′ receives the signal and necessary parameters for a requested charging in step 71. The rating device accesses the tariff or rating tree including the branch 60 of FIG. 6 in response to the requested service, i.e the call from a PLMN subscriber to a PSTN subscriber, in step 72. The rating is performed by entering the branch 61 in step 72 followed by testing of the conditions 62-64 one after the other in steps 73-75. If the last condition is fulfilled the rating proceeds with accessing the GetSum modifier 65 in step 76. Relevant parameters including are also provided when accessing the GetSum modifier 65. The parameters can be used time (when known after it has been used) or estimated time (when a reservation is to be done before something has been used) from the reservation process, state of call (start, within call, end of call). For this entry the fee will most probably only be used at start of call as a “connection fee” or call “attempt fee”. These parameters are however specific for the shown example. Depending on the parameters provided to the GetSum modifier operator the operator returns the sum of the modifier result in the set of modifiers, i.e one or more of the modifiers 66-68 are added to form a result returned by the rating device 1 of the charging device 1′ to the charging request in step 77. The steps 70-77 can include one or more additional sub-steps, all of which are not described herein in detail. The charging and rating function CRF of the charging device 1 collects or accesses charging input parameters or data such as: service data, subscriber related data, session data, call data, system data etc, received from the external service element of a service requested by a subscriber.

Although only one modifier operator has been disclosed in each of the embodiments described herein, it should be understood by the skilled person that the technology disclosed herein is not limited thereto. Additional modifier operators that are provided within the scope of the technology disclosed herein are GetMin that returns the individual cost from the modifier result that has the smallest cost in the modifier set, e.g. bearer, service cost and a fee to limit the maximum cost; GetMax that returns the individual cost from the modifier result that has the largest cost in the modifier set, e.g. bearer and service; GetMinRate that selects and returns the individual minimum rate from the set of modifiers in the node; GetMaxRate that selects and returns the individual maximum rate form a set of modifiers; GetSumOfFee that returns the sum of all individual fees; and GetSumOfRates that returns the sum of all individual rate, e.g. air and land rates. The name of the different modifier operators and the different modifiers are only examples and thus other names can be used for operators and modifiers with the same meaning as those described herein.

A rating tree can also have choice/if statements as macros. E.g IF account>amount then GetSum ELSE GetMin.

Moreover, the modifier operator can be defined to operate on all following given modifiers, all modifiers in a set of modifiers, a specified number of following given modifiers, fees only, rates only etc. In addition, the modifier operations can also state boolean expressions, giving at least the same possibilities as the tree structure itself, i.e “AND” and “OR” operators etc. The operations can be on true/false basis or on strings etc.

The method of the technology disclosed herein is preferably implemented in computer software executable preferably by a data processing apparatus or system forming part of the overall communication system. In this embodiment of the technology disclosed herein, the computer processor of the operator in the network is configured to work the steps of the method.

Hence, it should be apparent that the technology disclosed herein provides an improved method and device for use in an electronic communication network, comprising a rating and charging mechanism that provides for determining rating data for services in a communications network to a user in a communications system that fully satisfies the aims and advantages set forth above. Among other advantages, the technology disclosed herein makes it possible for a rating service to operate efficiently on several modifiers affected by the same event and their result, i.e for example their total cost such as reservation interval or event cost and could be the rate/units or fixed fee, and additionally optimizing on a specific result such as a reservation.

Although the technology disclosed herein has been described in conjunction with specific embodiments thereof this technology disclosed herein is susceptible of embodiments in different forms, with the understanding that the present disclosure is to be considered as an exemplification of the principles of the technology disclosed herein and is not intended to limit the technology disclosed herein to the specific embodiments illustrated. Particularly rating trees or part of rating trees of FIG. 4 and FIG. 6 are only examples and are not intended to limit the scope of the technology disclosed herein. The method and device according to the technology disclosed herein are configurable to operate on a variation of rating trees or part of rating trees.

The method of the technology disclosed herein can also be implemented in computer software executable preferably by a distributed data processing system forming part of the overall communication system.

What is claimed is:

1. A method for determining rating data for charging of services in an electronic communications network, comprising:
in response to a charging request from a service element for a requested service in the electronic communications network, accessing a modifier operator of a node of a branch of a tariff structure for determining a result to be returned in response to the charging request, said modifier operator performing at least one operation involving a number of modifiers each representing real cost or rate values, and
returning a result from said at least one operation.

2. A method according to claim 1, wherein said modifier operator returns the individual cost from the modifier result that has the smallest cost in the modifier set; or returns the individual cost from the modifier result that has the largest cost in the modifier set; or selects and returns the individual minimum rate from the modifiers; or selects and returns the individual maximum rate form a set of modifiers; or returns the sum of all individual fees; or returns the sum of all individual rates.

3. A method according to claim 1, wherein said requested service is to send an MMS of N kBytes from a subscriber having a mobile phone to one or more internal HPLMN subscribers and one or more external HPLMN subscribers and that said operator performs a sum operation of the modifiers forming a fee for HPLMN receivers and a fee for non-HPLMN receivers and the rate per original unit of information to be sent.

4. A method according to claim 1, wherein said requested service is to make a call from a subscriber having a mobile phone to a PSTN subscriber and that said operator performs a sum operation of the modifiers forming a fee for call set-up, a rate for air connection, and a rate for land connection.

5. A charging device for determining rating data for charging of services in an electronic communications network, comprising:
a modifier operator of a node; and
a computer processing apparatus adapted to access the modifier operator of a node of a branch of a tariff structure for determining a result to be returned in response to a charging request from a service element for a requested service in the electronic communications network, wherein said modifier operator is configured to perform at least one operation involving a number of modifiers each representing real cost or rate values, and return a result from said at least one operation.

6. A charging device according to claim 5, wherein said modifiers are a fee for HPLMN receivers and a fee for non-HPLMN receivers and the rate for the amount of information to be sent, and that said operator is configured to perform and return a sum of the said modifiers.

7. A charging device according to claim 5, wherein said modifiers are a fee for call set-up, a rate for air connection, and a rate for land connection and that said operator is configured to perform and return a sum of the said modifiers.

8. A charging device according to claim 5, wherein said modifier operator is configured to return the individual cost from the modifier result that has the smallest cost in the modifier set; or return the individual cost from the modifier result that has the largest cost in the modifier set; or select and return the individual minimum rate from the modifiers; or select and return the individual maximum rate form a set of modifiers; or return the sum of all individual fees; or return the sum of all individual rates.

9. A computer program comprising program instructions stored on a non-transitory computer readable carrier which, when executed, cause a computer to perform the method of claim 1.

10. A computer program according to claim 9, wherein said carrier is a record medium, a computer memory, or a read-only memory.

11. A charging device for determining rating data for charging services in an electronic communications network, the charging device comprising:
a rating device including a computer apparatus; and
a database with service data needed for the service, including tariff data and subscriber data, adapted to perform the method of claim 1.

12. A method for determining rating data for charging of services in an electronic communications network, comprising:
maintaining a tariff structure at a charging system, the tariff structure being configured as a rating tree having plural rating tree nodes including a modifier operator node and modifier leafs, the modifier operator node being associated with a modifier operator and each modifier leaf being associated with a respective modifier, each modifier representing a real cost or rate value;
in response to a charging request from a service element for a requested service in the electronic communications network, using the processor in one traversal of the rating tree to access the modifier operator and to use the modifier operator to perform at least one operation involving a number of the modifiers for determining a result to be returned in response to the charging request; and
the processor returning a result from said at least one operation.

13. The method of claim 12, wherein the plural modifier leafs are leafs of a same rating tree node.

14. The method of claim 12, wherein the modifier operator is a summation operation performed with respect to plural modifiers.

15. A charging device for determining rating data for charging of services in an electronic communications network, comprising:
a computer-implement tariff structure configured as a rating tree having plural rating tree nodes including a modifier operator node and modifier leafs, the modifier operator node being associated with a modifier operator and each modifier leaf being associated with a respective modifier, each modifier representing a real cost or rate value;
a processing configured in one single traversal of the rating tree to:
access the modifier operator in a rating analysis in response to a charging request from a service element for a requested service in the electronic communications network;
use the modifier operator to perform at least one operation involving a number of modifiers; and
return a result from the at least one operation.

16. The charging device of claim 15, wherein the plural modifier leafs are leafs of a same rating tree node.

17. The charging device of claim 15, wherein the modifier operator is a summation operation performed with respect to plural modifiers.
